(19) United States
(12) Patent Application Publication
(10) Pub. No.: US 2016/0290947 A1
(43) Pub. Date: Oct. 6, 2016

(54) GAS SENSOR

(71) Applicant: HONDA MOTOR CO., LTD., Tokyo (JP)

(72) Inventors: Akihiro SUZUKI, Wako-shi, Saitama-ken (JP); Takashi KAWAURA, Wako-shi, Saitama-ken (JP)

(21) Appl. No.: 15/036,151

(22) PCT Filed: Nov. 10, 2014
(86) PCT No.: PCT/JP2014/079746

§ 371 Date: May 12, 2016

(30) Foreign Application Priority Data
Nov. 15, 2013 (JP) 2013-236496

(51) Int. Cl. G01N 27/18; G01N 25/18

(52) U.S. Cl. CPC G01N 27/18; G01N 25/18

(57) ABSTRACT

A gas sensor is provided with a detection element, a circuit board, and a housing that houses the detection element and the circuit board. The housing has a first fastening section, a second fastening section, and a gas introducing port. The center of the gas introducing port is positioned on a virtual line connecting the first fastening section and the second fastening section, and is disposed corresponding to a corner section of the circuit board, said corner section being close to the first fastening section side.

### TECHNICAL FIELD

The present invention relates to a gas sensor including a detection element configured to contact a gas as a detection target, a circuit board for supporting the detection element and obtaining information of the contacted gas, and a casing containing the detection element and the circuit board.

### BACKGROUND ART

For example, a solid polymer electrolyte fuel cell has a membrane electrode assembly (MEA). The membrane electrode assembly includes a polymer ion exchange membrane as an electrolyte membrane, and an anode and a cathode provided on both sides of the electrolyte membrane. The membrane electrode assembly is sandwiched between separators (bipolar plates) to form a power generation cell. In the fuel cell, normally, a predetermined number of the power generation cells are stacked together to form an in-vehicle fuel cell stack mounted in a fuel cell vehicle (fuel cell electric automobile), for example.

In the fuel cell vehicle, in particular, it is required to monitor leakage of hydrogen as a fuel gas. For this purpose, for example, gas sensors for use of hydrogen detection have been used. As a gas sensor, normally, a contact combustion type hydrogen sensor or a heat conductivity type hydrogen sensor has been used. Normally, the heat conductivity type hydrogen sensor detects hydrogen concentration and humidity by electrically detecting a change in the temperature of the heat emitting element (resistive element) caused by the difference in hydrogen heat conductivity, as a change in the resistance value of the temperature detection element.

As techniques of this type, for example, a gas sensor disclosed in Japanese Patent No. 4165300 and a gas detection apparatus disclosed in Japanese Laid-Open Patent Publication No. 2013-221862 are known.

### SUMMARY OF INVENTION

In this regard, a gas sensor used in a fuel cell vehicle needs to be placed in a limited, narrow and small space, and thus it is desirable to downsize such a gas sensor. However, in Japanese Patent No. 4165300 and Japanese Laid-Open Patent Publication No. 2013-221862, the size of the gas sensor cannot be reduced effectively.

The present invention has been made to solve the problem of this type, and an object of the present invention is to provide a gas sensor having the desired detection function where the structure of the gas sensor is simplified easily, and size reduction of the gas sensor is achieved.

The gas sensor according to the present invention includes a detection element configured to contact a gas as a detection target, a polygonal circuit board configured to support the detection element and obtain information of the contacted gas, and a casing containing the detection element and the circuit board.

The casing includes a first fastening section and a second fastening section fastened to a gas sensor mounting position and a gas inlet port configured to allow the gas to flow into the gas inlet port to contact the detection element. A center of the gas inlet port is positioned on a virtual line connecting the first fastening section and the second fastening section, and the gas inlet port is provided at a corner of the circuit board adjacent to the first fastening section.

In the present invention, since the gas contacts the detection element, the center of the gas inlet port for allowing entry of the gas is positioned on the virtual line connecting the center of the first fastening section and the center of the second fastening section. In the structure, it becomes possible to maintain the surface pressure of the gas inlet port at the desired level, and maintain the desired sealing function.

Further, the center of the gas inlet port is positioned at the corner of the circuit board adjacent to the first fastening section. Therefore, since the gas inlet port is positioned in a dead space at the corner of the circuit board, the area of the dead space in the circuit board is reduced, and size reduction of the circuit board is achieved.

Accordingly, the gas sensor has the desired function of detecting the hydrogen concentration, and it becomes possible to simplify the overall structure of the gas sensor and reduce the overall size of the gas sensor.

### BRIEF DESCRIPTION OF DRAWINGS

FIG. 1 is a perspective view showing a state where a gas sensor according to a first embodiment of the present invention is mounted;

FIG. 2 is a cross sectional view showing the gas sensor, taken along a line II-II in FIG. 1;

FIG. 3 is a plan view showing the gas sensor;

FIG. 4 is a plan view showing a circuit board and a detection element of the gas sensor;

FIG. 5 is a cross sectional view showing a gas sensor according to a second embodiment of the present invention;

FIG. 6 is a cross sectional view showing a gas sensor according to a third embodiment of the present invention; and

FIG. 7 is a plan view showing a circuit board and a detection element of the gas sensor.

### DESCRIPTION OF EMBODIMENTS

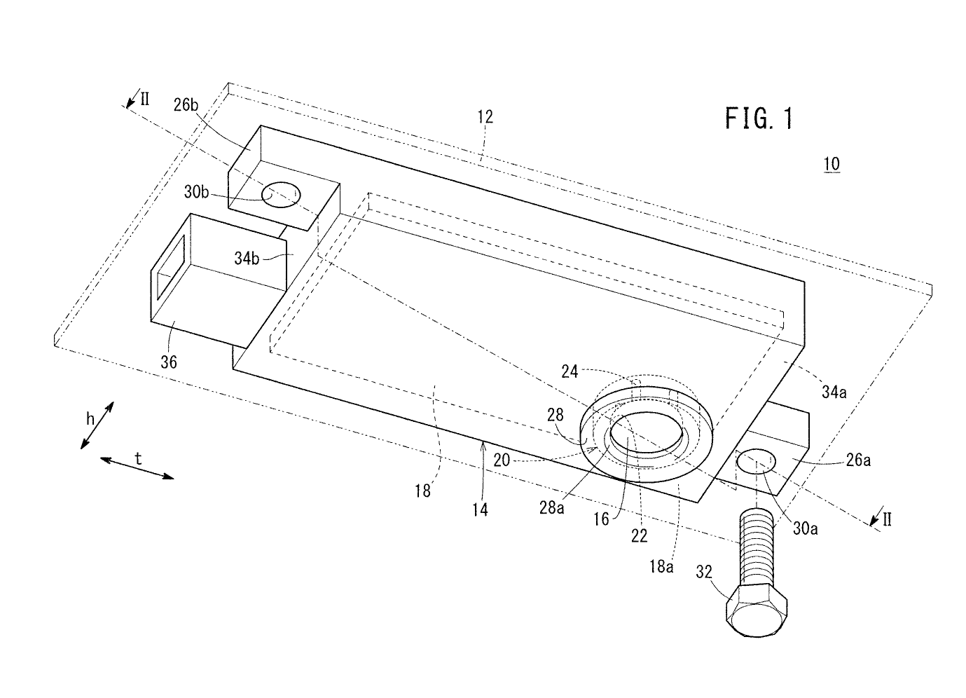

A gas sensor 10 according to a first embodiment of the present invention shown in FIGS. 1 to 3 is a heat conductivity type hydrogen sensor. For example, the gas sensor is mounted in a fuel cell electric vehicle (not shown), and used for detecting leakage of a hydrogen gas (fuel gas).

The gas sensor 10 includes a casing 14 fixed to a mounting section (gas sensor mounting position) 12 of the vehicle. A detection element 16 and a circuit board 18 are embedded (contained) in the casing 14. The detection element 16 contacts hydrogen (gas) as a target of detection, and the detection element 16 is supported on the circuit board 18. The circuit board 18 obtains concentration (information) of the hydrogen which contacts the detection element 16.

For example, the detection element 16 is a heat emitting element (heat emitting resistor) having a circular disk shape. When the detection element 16 contacts the hydrogen, the temperature of the detection element 16 changes depending on heat conductivity of the hydrogen. A power supply (not shown) for supplying electric current and a voltmeter (not shown) for measuring the voltage applied to both terminals of the detection element 16 are connected to the detection element 16. The resistance value of the detection element 16 changes according to the change in its temperature. The hydrogen concentration can be detected by measuring the voltage.

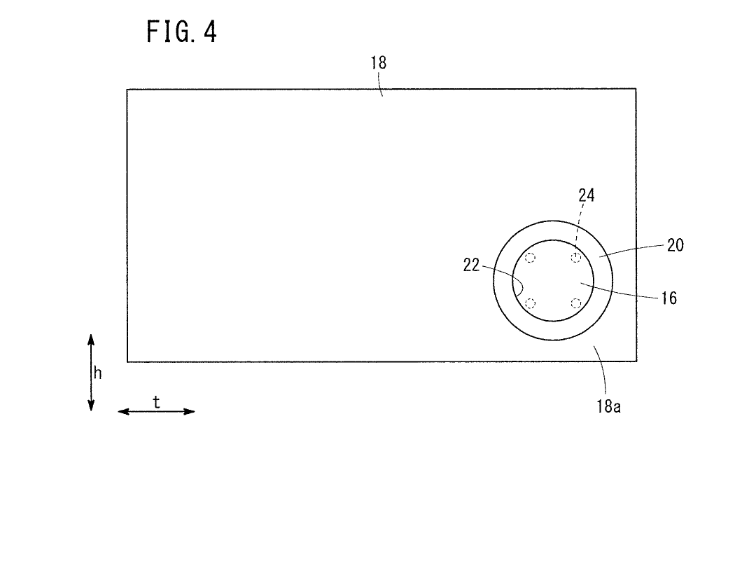

As shown in FIG. 4, the circuit board 18 has a quadrangular (polygonal) shape, e.g., rectangular shape in a plan view. Illustration of the circuit pattern provided in the circuit board 18 is omitted. A detection element 16 is attached to (supported on) a position adjacent to one corner 18a of the circuit board 18 through a heat insulating case 20.

For example, the heat insulating case 20 is formed using a heat insulating member of ceramic, glass, etc. The heat insulating case 20 has a circular disk shape, and a recess 22 is formed at the center of the heat insulating case 20 for placing the detection element 16 in the recess 22. The heat insulating case 20 is directly joined to the circuit board 18 by adhesion, welding, etc., and the detection element 16 and the circuit board 18 are electrically connected through a plurality of connecting wires 24.

As show in FIGS. 1 to 3, for example, parts of the casing 14 are formed integrally using a resin member. The detection element 16 and the circuit board 18 are embedded in the casing 14 by insert molding. The casing 14 has a quadrangular (polygonal) shape, e.g., rectangular shape in a plan view. The casing 14 has a first fastening section 26a and a second fastening section 26b fastened to the mounting section 12 of the vehicle, and a gas inlet port 28. Hydrogen is supplied into the gas inlet port 28 for allowing the hydrogen to contact the detection element 16.

The first fastening section 26a has a hole 30a and the second fastening section 26b has a hole 30b. Bolts 32 are inserted into the holes 30a, 30b, and screwed into the mounting section 12 of the vehicle for attaching the casing 14 to the mounting section 12 of the vehicle. A curved R-shaped portion 28a is formed in an end of an inner wall surface of the gas inlet port 28 that is positioned opposite to the detection element 16. Instead of the R-shaped portion 28a, a chamfered (taper cut) portion may be adopted.

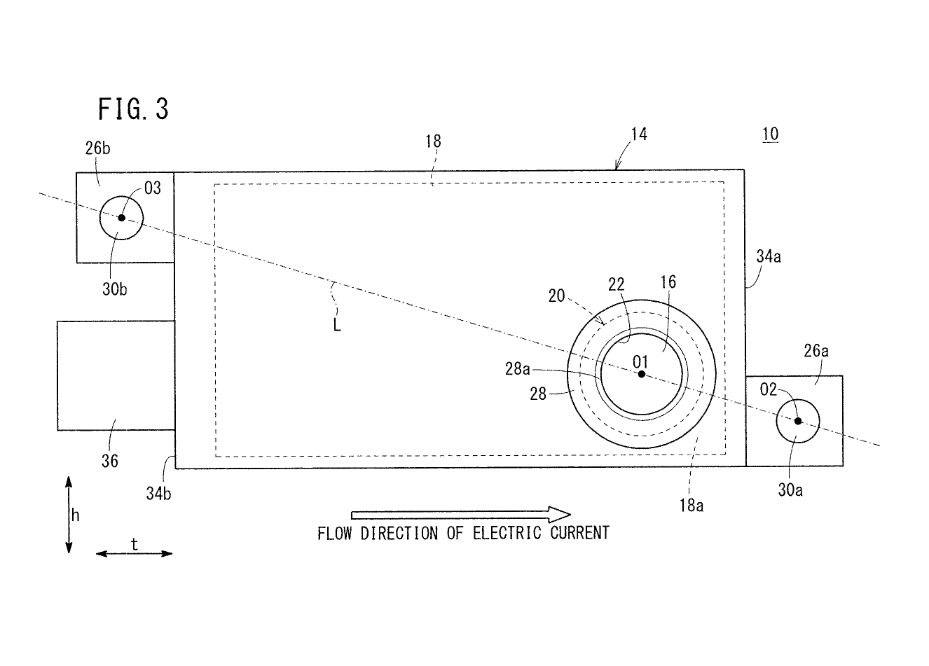

As shown in FIG. 3, the center O1 of the gas inlet port 28 is positioned on a virtual line L connecting the center O2 of the first fastening section 26a and the center O3 of the second fastening section 26b, and provided at a corner 18a of the circuit board 18 adjacent to the first fastening section 26a. Specifically, the first fastening section 26a and the second fastening section 26b are provided at diagonal positions on opposite sides, i.e., a first side (one short side) 34a and a second side (the other short side) 34b of the casing 14, respectively.

In the first embodiment, the first side 34a or the second side 34b has a connector insertion slot 36, and a connector (not shown) for supplying electricity to the gas sensor 10 is inserted into the connector insertion slot 36. The connector insertion slot 36 is formed adjacent to an end of the second side 34b, oppositely to an end of the second side 34b where the second fastening section 26b is provided.

Operation of this gas sensor 10 will be described below.

The gas sensor 10 is attached to the mounting section 12 of the vehicle, and when significant amount of the hydrogen is accumulated along the mounting section 12 of the vehicle as a ceiling plate, the position of the hydrogen border (hydrogen level) is lowered. When the hydrogen level goes down to a lower position of the casing 14, the hydrogen enters the gas inlet port 28 of the casing 14. Consequently, the hydrogen contacts the detection element 16, and hydrogen concentration is detected.

In the first embodiment, as shown in FIG. 3, since the hydrogen contacts the detection element 16, the center O1 of the gas inlet port 28 for allowing entry of the hydrogen is positioned on the virtual line L connecting the center O2 of the first fastening section 26a and the center O3 of the second fastening section 26b. In the structure, it becomes possible to maintain the surface pressure of the gas inlet port 28 at the desired level, and maintain the desired sealing function.

Further, the center O1 of the gas inlet port 28 is positioned at the corner 18a of the circuit board 18 adjacent to the first fastening section 26a. In the structure, since the gas inlet port 28 is positioned in a dead space at the corner 18a of the circuit board 18, the area of the dead space of the circuit board 18 is reduced, and size reduction of the circuit board 18 is achieved.

Accordingly, the gas sensor 10 has the desired function of detecting the hydrogen concentration, and it becomes possible to simplify the overall structure of the gas sensor 10 and reduce the overall size of the fuel gas sensor 10.

Further, in the first embodiment, the casing 14 has a quadrangular (polygonal) shape, e.g., rectangular shape in a plan view. The first fastening section 26a and the second fastening section 26b are provided on opposite sides, i.e., on the first side 34a and the second side 34b of the casing 14, respectively. The connector insertion slot 36 is formed adjacent to the end of the second side 34b, oppositely to the end of the second side 34b where the second fastening section 26b is provided.

In the structure, the second side 34b has the second fastening section 26b and the connector insertion slot 36. Therefore, size reduction of the gas sensor 10 is achieved easily, and the mounting position of the gas sensor 10 can be determined freely.

Moreover, the second fastening section 26b and the connector insertion slot 36 protrude in the same direction (indicated by an arrow t in FIG. 3) from the second side 34b. Therefore, the dimension of the casing 14 in a direction indicated by an arrow h is reduced as much as possible, and size reduction of the casing 14 is achieved easily. Further, the first side 34a only has the first fastening section 26a. Thus, the gas sensor 10 has an asymmetrical shape, and it is possible to reliably prevent assembling mistakes.

Further, the connector insertion slot 36 is provided on the second side 34b together with the second fastening section 26b which is provided at a relatively large distance from the gas inlet port 28. In the structure, since the detection element 16 is provided in consideration of the flow of electric current on the circuit board 18 (see the flow direction of electric current in FIG. 3), the circuit pattern is simplified, and size reduction of the circuit board 18 is achieved effectively.

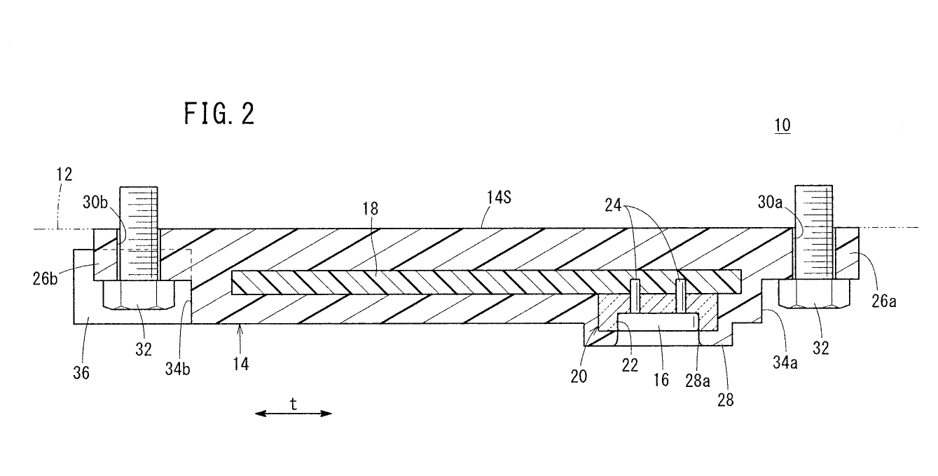

Moreover, as shown in FIG. 2, the casing 14 includes a flat fastening surface 14S facing the mounting section 12 of the vehicle. Therefore, the distance between the fastening surface 14S and the detection element 16 is reduced suitably, and detection of the hydrogen accumulated on the ceiling plate is performed rapidly. Further, the curved R-shaped portion 28a is formed at the inner end of the inner wall surface of the gas inlet port 28 opposite to the detection element 16. In the structure, the water is not retained on the wall surface by its surface tension, and it becomes possible to suppress influence on the gas sensor 10 due to the humidity.

Further, the detection element 16 is placed in the recess 22 of the heat insulating case 20. Therefore, the heat of the detection element 16 is not emitted to the circuit board 18, and it is possible to suppress decrease in the detection accuracy. Moreover, it becomes possible to reduce the distance between the detection element 16 and the circuit board 18. Reduction in the overall thickness and size of the gas sensor 10 is achieved easily.

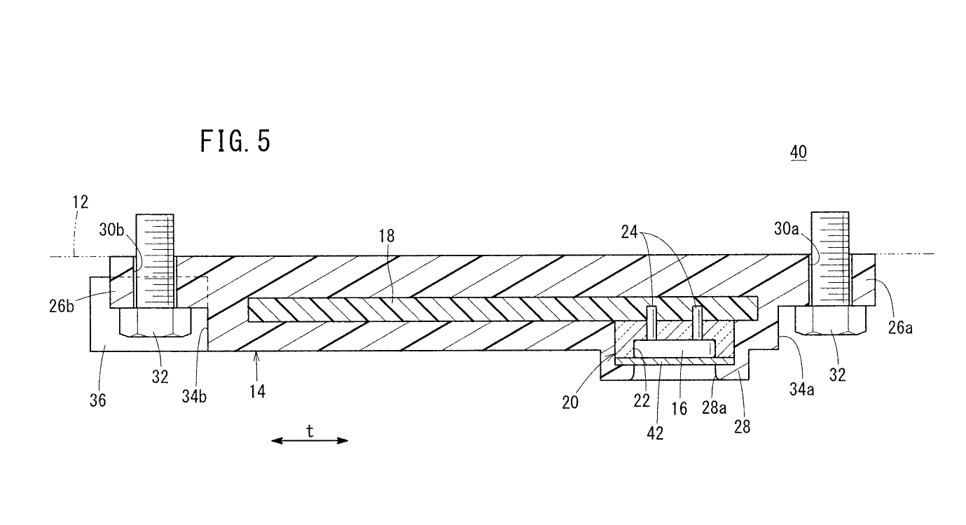

FIG. 5 is a cross sectional view showing a gas sensor 40 according to a second embodiment of the present invention. The constituent elements that are identical to those of the gas sensor 10 according to the first embodiment are labeled with the same reference numerals and description thereof is omitted. Further, also in a third embodiment described later, description of the constituent elements that are identical to those of the gas sensor 10 according to the first embodiment is omitted.

In the gas sensor 40, an explosion proof filter is directly connected to the heat insulating case 20. For example, the explosion proof filter 42 comprises a metal mesh or a porous body. Instead of the explosion proof filter 42, or in combination with the explosion proof filter 42, a water repellent filter (not shown) may be used. The water repellent filter is a hydrogen permeable filter, and is not a liquid (water droplet) permeable filter.

In the second embodiment, the same advantages as in the case of the first embodiment are obtained, and additionally, an explosion proof function (and a water repellent function) can be provided.

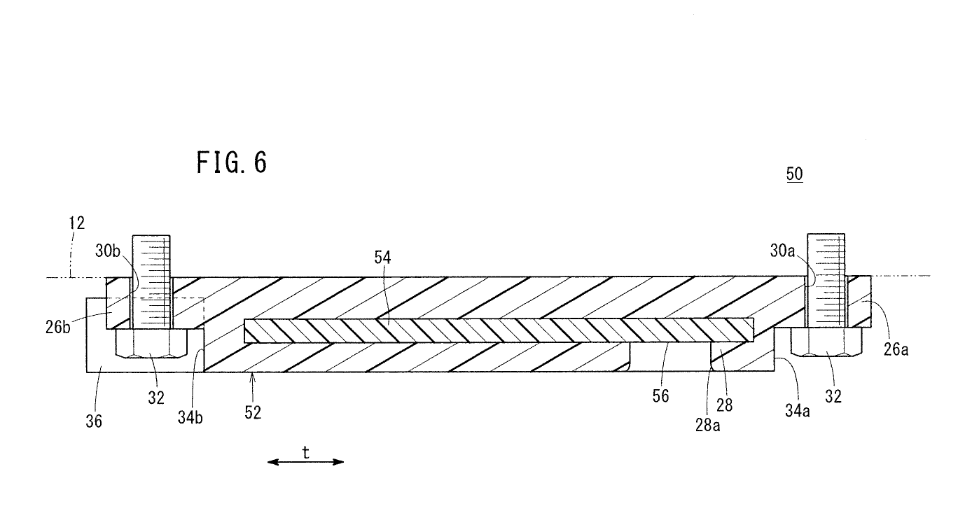

FIG. 6 is a cross sectional view showing a gas sensor 50 according to the third embodiment of the present invention.

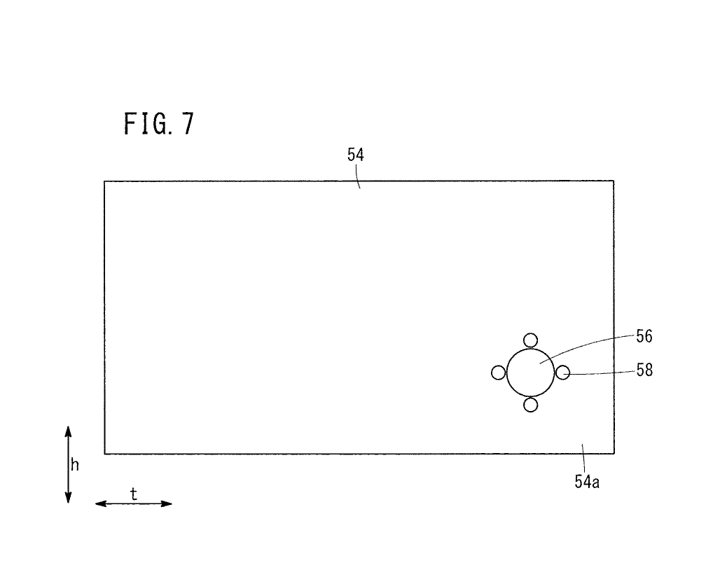

The gas sensor 50 includes a casing 52, and a circuit board 54 is embedded (contained) in the casing 52. As shown in FIG. 7, the circuit board 54 has a quadrangular (polygonal) shape, e.g., rectangular shape in a plan view. A detection element 56 is formed integrally with the circuit board 54, at a position adjacent to one corner 54a of the circuit board 54.

The detection element 56 directly forms an element pattern in the circuit board 54. A plurality of, e.g., four heat insulating holes 58 extend through the circuit board 54 around the detection element 56. The heat insulating holes 58 are formed for preventing heat emission from the detection element 56 to the circuit board 54.

In the third embodiment, it is not required to provide a detection element and a heat insulating case separately from the circuit board 54. Therefore, it becomes possible to reduce the thickness (size) of the gas sensor 50 as much as possible. Additionally, in the third embodiment, the same advantages as in the case of the first embodiment are obtained.

1. A gas sensor comprising:
a detection element configured to contact a gas as a detection target;
a polygonal circuit board configured to support the detection element and obtain information of the contacted gas; and
a casing containing the detection element and the circuit board,
wherein the casing includes:
a first fastening section and a second fastening section fastened to a gas sensor mounting position; and
a gas inlet port configured to allow the gas to flow into the gas inlet port to contact the detection element; and
a center of the gas inlet port is positioned on a virtual line connecting the first fastening section and the second fastening section, and the gas inlet port is provided at a corner of the circuit board adjacent to the first fastening section.

2. The gas sensor according to claim 1, wherein the casing has a quadrangular shape in a plan view;
the first fastening section and the second fastening section are provided at diagonal positions on opposite first and second sides of the casing, respectively; and
the first side or the second side has a connector insertion slot, and a connector configured to supply electricity to the gas sensor is inserted into the connector insertion slot.

3. The gas sensor according to claim 2, wherein the connector insertion slot is formed adjacent to an end of the second side, oppositely to an end of the second side where the second fastening section is provided.

4. The gas sensor according to claim 1, wherein a heat insulating member is interposed between the detection element and the circuit board.

5. The gas sensor according to claim 1, wherein a curved R-shaped portion is formed at an end of an inner wall surface of the gas inlet port opposite to the detection element.

6. The gas sensor according to claim 1, wherein the detection element is formed integrally with the circuit board.
